(19) United States
(12) Patent Application Publication
(10) Pub. No.: US 2008/0288974 A1
(43) Pub. Date: Nov. 20, 2008

(54) SYSTEMS AND METHODS FOR OUTPUTTING ADVERTISEMENTS WITH ONGOING VIDEO STREAMS

(76) Inventors: Jamie Dierlam, Monroe, WA (US); Larry Schreurs, Carnation, WA (US)

Correspondence Address: BLACK LOWE & GRAHAM, PLLC, 701 FIFTH AVENUE, SUITE 4800, SEATTLE, WA, 98104, US

(21) Appl. No.: 12/122,633

(22) Filed: May 16, 2008

Related U.S. Application Data
(60) Provisional application No. 60/938,941, filed on May 18, 2007.

(51) Int. Cl. H04N 7/10

(52) U.S. Cl. 725/32

(57) ABSTRACT

Systems and methods for outputting advertisements with ongoing video streams are disclosed. A method for outputting advertisements to a display in conjunction with a video stream includes outputting a video stream to a user containing embedded advertisement information for display on a display device. Displaying an advertising display module within the video stream, when a user selects an area of the video screen containing an object that has linked advertisement information. Removing the advertising display module from the video stream when at least one of a time limit expires and a user closes the advertising display module occurs.

### PRIORITY CLAIM

This application claims the benefit of the filing date of U.S. Provisional Patent Application No. 60/938,941 filed on May 18, 2007, which is herein incorporated by reference in its entirety.

### BACKGROUND OF THE INVENTION

During the course of “live” video content, i.e., an active video stream, numerous items are displayed to viewers. Quite often, many if not all of the items viewed are presented favorably such that the viewer may also become a consumer of that item. For example, a lead actress may be shown in a particularly attractive evening gown such that a viewer might want to know more about the maker/label to investigate it for herself. Unfortunately, since the video content is “live,” the opportunity to determine the designer of the dress is lost. The disclosed subject matter provides a system and method for permitting viewers to view information, such as advertisements, of various items displayed on a display device in the course of an active video stream.

### SUMMARY OF THE INVENTION

Systems and methods for outputting advertisements with ongoing video streams are disclosed. A method for outputting advertisements to a display in conjunction with a video stream includes outputting a video stream to a user containing embedded advertisement information for display on a display device. Displaying an advertising display module within the video stream when a user selects an area of the video screen containing an object that has linked advertisement information. Removing the advertising display module from the video stream when at least one of a time limit expires and a user closes the advertising display module occurs.

### BRIEF DESCRIPTION OF THE DRAWINGS

The preferred and alternative embodiments of the present invention are described in detail below with reference to the following drawings.

FIGS. 1A and 1B are pictorial diagrams illustrating exemplary environments for interactively outputting advertisements and ongoing video content for display on a display device;

FIG. 2 is a pictorial diagram representative of the display of an ongoing video stream on a display device;

FIG. 3 is the pictorial diagram of FIG. 2 displaying an advertisement in response to a viewer selecting an item in the ongoing video stream;

FIG. 4 shows an illustrative routine for outputting advertisement content superimposed over an ongoing video stream;

FIG. 5 is a flow diagram illustrating a routine for obtaining advertisement information.

### DETAILED DESCRIPTION OF THE PREFERRED EMBODIMENT

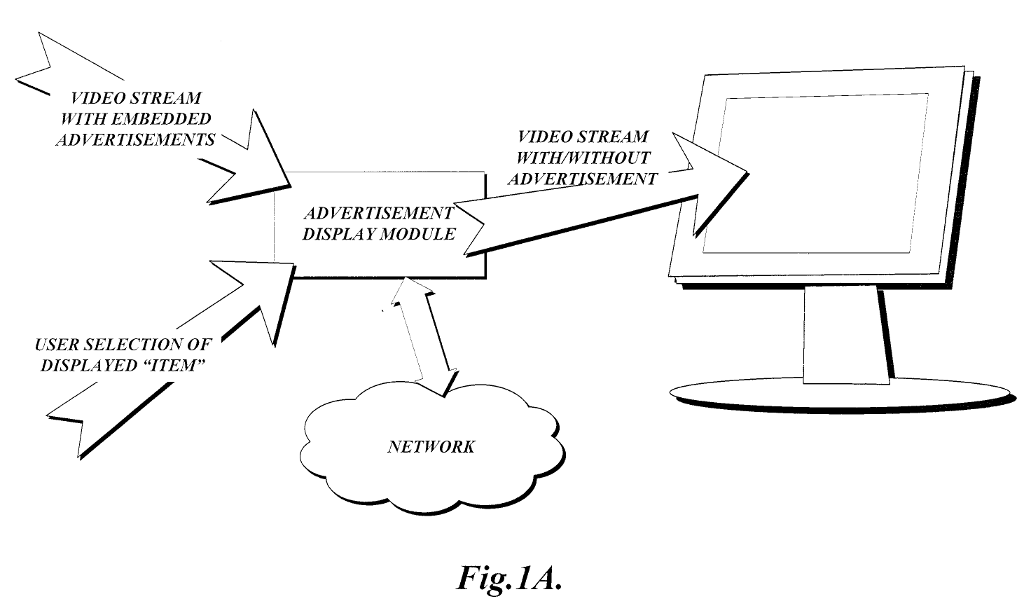

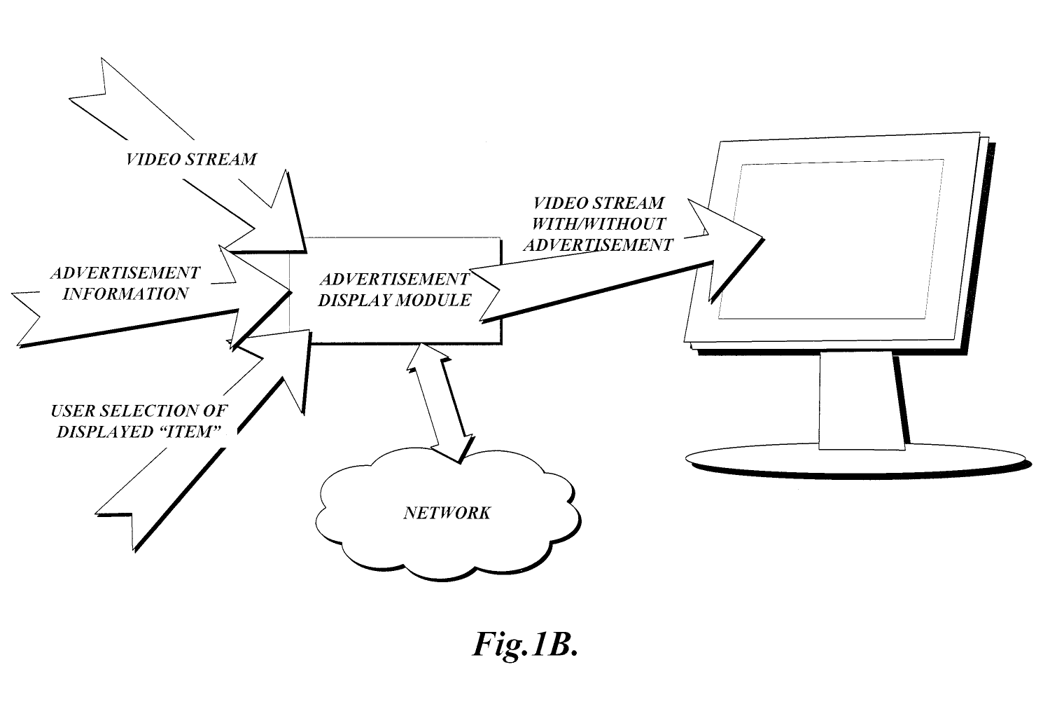

Turning to FIG. 1A, an illustrative environment 100 for interactively outputting advertisements for display on a display device is presented. The illustrative environment 100 includes a video stream 102 that includes embedded advertisement information that may be output for display on a display device 108 according to user selection 104 as indicated by a user interface, such as a remote control device 114. The remote control device 114 provides the user selection 104 to an advertisement display module 106. The video stream 102 with embedded advertisement flows, at least in part, to the advertisement display module 106. According to the illustrated embodiment, the advertisement display module 106 includes the ability to detect the user selection 104, determine an item in the ongoing video stream corresponding to the user selection, extract advertisement information from the video stream 102, and output the ongoing video stream 112 to the display device with or without an advertisement superimposed over the ongoing video stream according to the user selection.

The advertisement display module 106 may be connected to a network 110, such as the Internet, such that the embedded advertisement information identifies a source for providing additional information regarding the advertisement. Further still, the advertisement may be a “live” advertisement that allows a viewer to interact with the advertisement, such as being able to purchase an advertised item.

Turning to FIG. 1B, this is an alternative illustrative environment 150 for outputting advertisements for display on a display device in conjunction with an ongoing video stream. In particular, a “typical” video stream 152 is provided, at least in part, to the advertisement display module 158. Also fed to the advertisement display module 158 is an advertisement stream 154 that corresponds with the live video stream 152. A user selection 156 is provided to the advertisement output module 158 from a user interface device 160. As indicated above, when a user selects an item in the ongoing video stream, the advertisement output module 158 determines which advertisement to output and outputs that advertisement to the display device superimposed over the ongoing video stream 162. As above, the advertisement output module 158 is connected to a network 162 for obtaining additional advertisement information or conducting a transaction according to information presented in the advertisement.

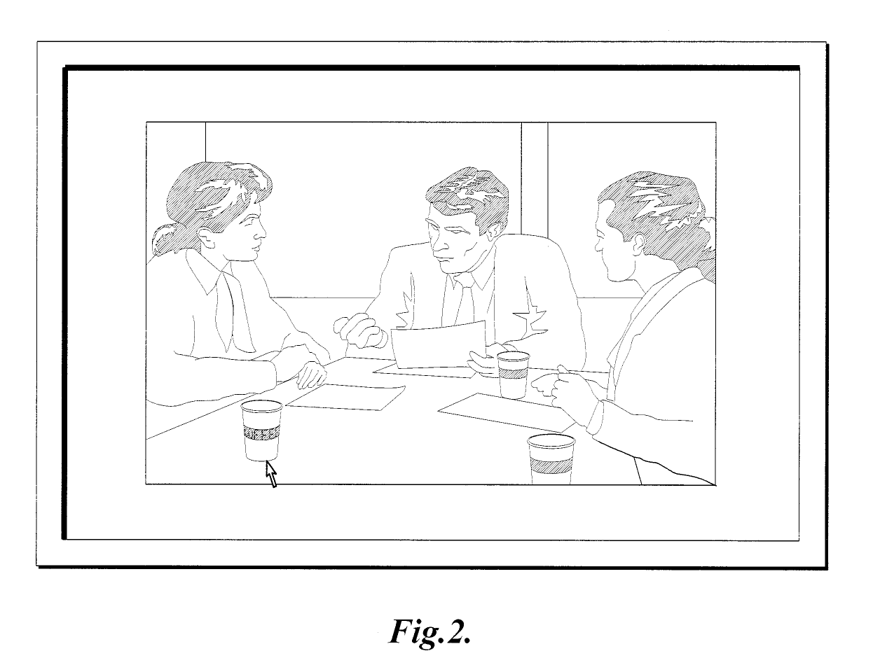

Turning to FIG. 2, this is a pictorial diagram to represent the display 200 of an ongoing video stream. As can be seen, there are several items displayed in the current “movie,” including several people seated around a table, likely in a business setting, discussing some matter. Each of the persons has a drink nearby. Also shown is a user interaction pointer—in this instance a pointer. The user interaction pointer allows the viewer to navigate to and select an item on the ongoing video stream. In one example, the item is represented by an icon displayed by the advertisement display module at the direction of a viewer to point to an item in the movie. Navigation and selection is handled by the advertisement display module 106 in conjunction with input from a user interface.

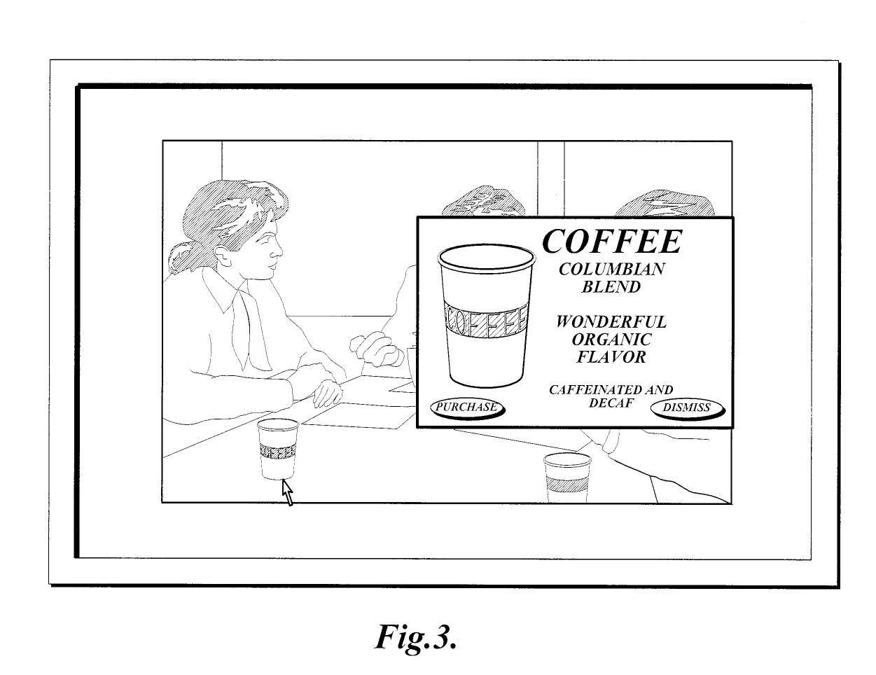

Turning to FIG. 3, this is a pictorial diagram to represent the ongoing video stream shown in the display 200 after a viewer has selected the person's drink in the lower left side of the display. As can be seen, an advertisement corresponding to the item selected via the user input to the advertisement display module is displayed over the top of the ongoing video stream. In this case, the advertisement corresponds to the coffee blend, presumably the type that is used in the ongoing movie. The displayed advertisement may be opaque (as shown), or alternatively, the advertisement may be displayed with a level of transparency so that the movie below is not fully obscured.

The advertisement information may be organized in a z-order or simply as tiled information. In the z-order, the advertisement may be viewed as being stacked. At the base level, an advertisement covers the entire display area such that if there are no other advertisements on a higher plane where the user selects, the base level is selected. However, in the z-order there may be additional advertisements that lie over the top of a base level, or a lower level such that if the user makes a selection, the highest level advertisement under the user selection is chosen. Alternatively, in a tiled information organization, areas on the screen are associated with an advertisement.

Video streams may originate from a variety of sources including portable media players, hard disk drives, broadcast signals, cable and/or satellite services, the Internet, and the like. The portable media players may include optical disc players (CD players, DVD players, Blue ray players, etc.), video tape players, digital tape players, and the like.

In one embodiment, video streams may be embedded with full advertisement data. Alternatively, embedded advertisements may include limited information but provide a means, such as a URL, to link to the location for additional information. Degrees between full advertisement information and mere links to full information are also contemplated.

The advertisement display module may be integrated within a variety of devices, or implemented as a standalone device. For example, the advertisement display module may be integrated within a display device (e.g., a television); a media player such as DVD player, etc.; in a satellite descrambling box; a cable TV box; a personal video recording device; and the like.

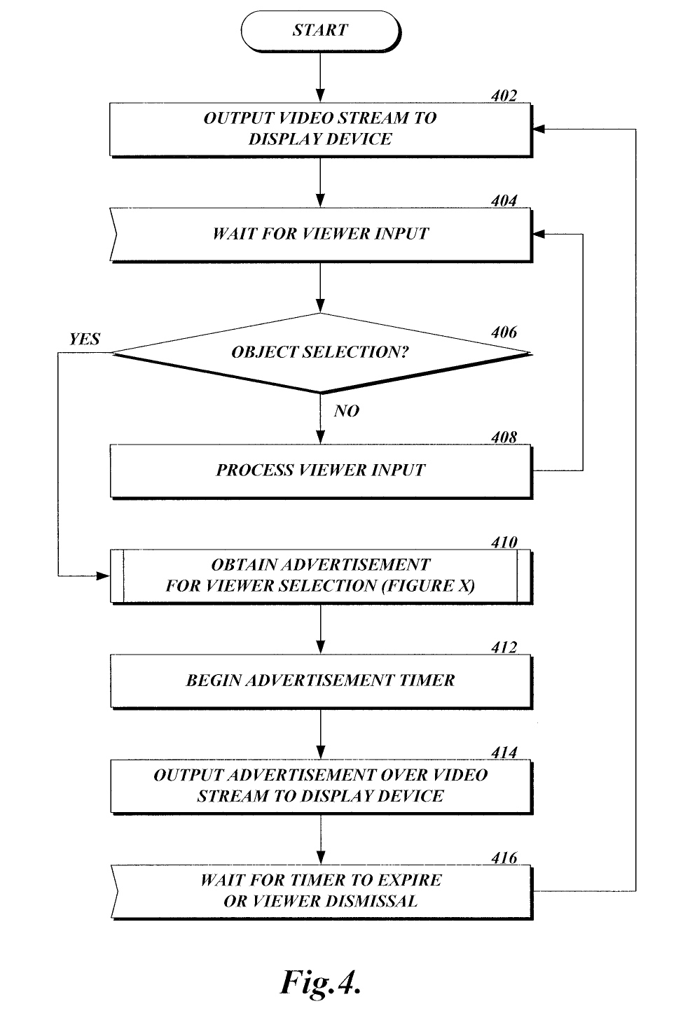

Turning to FIG. 4, an illustrative routine for outputting advertisement content superimposed over an ongoing video stream is presented. At 402, the video stream is output to the display device. At 404, while outputting the ongoing video stream to the display device, the advertisement display module waits for viewer input of an item on the display device. When received, at 406, a determination is made as to whether the viewer input was the selection of an object on the video stream such that an advertisement should be displayed. If not, the routine 400 processes the viewer input at 408 and returns to 402 to wait for additional viewer input.

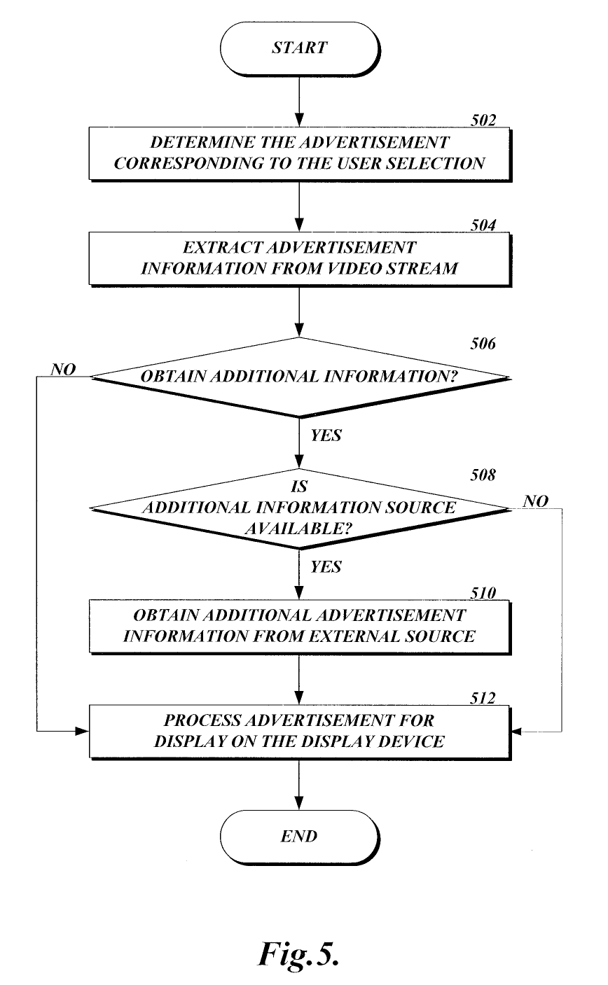

If the viewer input was the selection of an object, at 410 advertisement information corresponding to the viewer selection is obtained, as described below in FIG. 5. After obtaining the advertisement, at 412 an advertisement timer is begun to control the time that the advertisement is displayed on the output device. At 414, the advertisement is output to the display device. At 416, the system waits until the timer expires or the viewer expressly dismisses the advertisement. Once either occurs, the routine 400 returns to block 404.

FIG. 5 is a flow diagram illustrating a routine for obtaining advertisement information. At 502, the advertisement display module determines the advertisement corresponding to the viewer selection. At 504, the advertisement information is extracted from the video stream. Alternatively, the advertisement information is extracted from the advertisement stream described in FIG. 1B. At decision block 506, a determination is made as to whether additional information is available for the advertisement. If not, the routine proceeds to 512, and the advertisement information is processed for output to the display device. If there is additional advertisement information, at decision block 508 another determination is made as to whether the additional information source is available. If not, the routine proceeds to 512, and the advertisement information is processed for output to the display device. However, if the information source is available, at 510 the additional advertisement information is obtained. Subsequently, at 512 the advertisement information is processed for output to the display device. Thereafter, the routine 500 terminates.

As indicated above, advertisements may be interactive such that the viewer may obtain additional information regarding an item (i.e., more than was offered in the embedded advertisement) or interact with the advertisement to conduct a transaction at that time. Still further, a viewer should be able to dismiss the advertisement without waiting for the timer (discussed above) to expire. It should be appreciated that while the user is interacting with the advertisement, the timer may be suspended so that the advertisement does not disappear during viewer interaction. In yet another embodiment, unless a viewer interacts with the advertisement, the advertisement may slowly fade according to the amount of time displayed on the display device.

The interaction pointer will typically be hidden. Viewer movement of the pointer, or selection, will cause the interaction pointer to be displayed.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for outputting advertisements to a display in conjunction with a video stream, comprising:
outputting a video stream to a display device containing embedded advertisement information, the video stream including at least one object;
receiving a selection of the at least one object;
displaying an advertising display module in a z-order to superimpose the advertising display module on the video stream; and
removing the advertising display module from the video stream when at least one of a time limit expires and a user closes the advertising display module occurs.

2. The method of claim 1 wherein embedded advertisement information further comprises a plurality of objects within the stream linked to advertisement information.

3. The method of claim 1 wherein the selection of the at least one object, includes selection by means of an interaction pointer.

4. The method of claim 1 wherein the displaying an advertising display module further comprises displaying an advertisement module including at least one further object.

5. The method of claim 4 wherein the displaying of the advertising module includes downloading the advertising information by means of a network information source.

6. The method of claim 4 further comprising initiating a transaction in response to receiving a selection of a further object.

7. The method of claim 6 further comprising receiving purchase information from a user to complete the initiated transaction.

8. A method for receiving advertising information from a video stream output to a display, the video stream containing embedded advertisement information, the method comprising:
receiving a selection of an object within the embedded advertising information from an interaction pointer;
receiving a advertising module based upon the selection of the object; and
outputting the advertising module in z-order to the video stream output to the display.

9. The method of claim 8 further comprising receiving additional advertisement information from an additional information source upon selection of a further object, the further object being included in the advertising module.

10. The method of claim 8 wherein the advertising display module further comprises interactive advertisement information on the selected object.

11. The method of claim 8 wherein the advertising display module is received from a network, the network being configured to provide additional advertising information.

12. The method of claim 8 further comprising conducting a transaction based upon selection of the further object the advertising display module includes.

13. The method of claim 8 further comprising fading the advertising display module from the display after a predefined amount of time.

14. The method of claim 8 further comprising removing the advertising display module from the video stream when at least one of a time limit expires and a user closes the advertising display module occurs.

15. A method for interacting with a display having an interaction pointer, the display configured to display a video stream, comprising:
selecting an object using the interaction device from advertising information embedded within the video stream, the object included in the advertising information;
viewing an advertising display module overlaid in z-order onto the video stream in response to the selecting the object; and
initiating a transaction based upon the advertisement display module.

16. The method of claim 15 wherein the advertising display module further comprises interactive advertisement information on the selected object.

17. The method of claim 15 wherein the interactive advertising information is received from a network to provide additional advertising information.

18. The method of claim 15 further comprising conducting a transaction by selection of at least one further object the advertising display module includes.

19. The method of claim 15 further comprising fading the advertising display module from the display after a predefined amount of time.

20. The method of claim 15 further comprising receiving additional advertisement information from an additional information source in response to selection of a further object.
